(19) United States
(12) Patent Application Publication
(10) Pub. No.: US 2017/0093708 A1
(43) Pub. Date: Mar. 30, 2017

(54) HEADER TRANSFORMATION DATAPATH

(71) Applicants: Karl S. Papadantonakis, Agoura Hills, CA (US); Robert G. Southworth, Chatsworth, CA (US); Alain Gravel, Thousand Oaks, CA (US); Jonathan A. Dama, Encino, CA (US)

(72) Inventors: Karl S. Papadantonakis, Agoura Hills, CA (US); Robert G. Southworth, Chatsworth, CA (US); Alain Gravel, Thousand Oaks, CA (US); Jonathan A. Dama, Encino, CA (US)

(21) Appl. No.: 14/865,868

(22) Filed: Sep. 25, 2015

(51) Int. Cl. H04L 12/741; H04L 29/06

(52) U.S. Cl. CPC H04L 45/74; H04L 69/22

(57) ABSTRACT

A communication packet processing device may include a control stage coupled to receive multiple headers of a packet comprised of multiple words, and to determine a destination lane for each word of the multiple headers by counting previous words of the headers. The device may also include a level 1 permutation circuit coupled to the control stage to place each word into a correct lane responsive to the determined destination lane, and a level 2 permutation circuit coupled to the level 1 permutation t circuit o place each word into a correct designation lane responsive to the determined destination lane. Additional embodiments are also described.

### TECHNICAL FIELD

Embodiments described generally herein relate to processing of data packets sent or received through a network. Some embodiments relate to transformation of multiple headers of a data packet.

### BACKGROUND

Modern switching hardware supports multiple complex packet headers, such as Multi-Protocol Label Switching (MPLS), IP-in-IP, stacked VLAN, and IPv6 options. The headers may be modified at packet rates exceeding 800 million packets per second, and at low latency.

Low-latency modification of multi-header packets requires the use of multiple concurrent header modifications. A compactor enables standard transmission after multiple headers have been modified, and their individual sizes potentially changed. To maintain a throughput of one packet per cycle, this must be done as a wide datapath that concatenates all the headers in one highly parallel structure such as a very wide crossbar.

Previous multistage solutions such as butterfly (specifically, a unidirectional Clos) are unacceptable because their latency is too high and they are not sufficiently smaller than a crossbar. A radix-16 butterfly handles 16̂N words in 2N−1 permutation stages and also requires many stages of control logic.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating components of a switching platform in which methods in accordance with some embodiments can be implemented.

FIG. 2 is a block diagram of a control device in accordance with some embodiments.

FIG. 3 is a block diagram of a compactor to transform headers in a switch according to an example embodiment.

FIG. 4 is a block diagram of an alternative compactor to transform headers in a switch according to an example embodiment.

FIG. 5 is a flowchart illustrating a method of transforming multiple headers of a communication packet according to an example embodiment.

FIG. 6 is an illustration of example words of multiple headers being transformed via a multiple stage compactor according to an example embodiment.

FIG. 7 is a block diagram of a hardware switch in accordance with some embodiments.

### DETAILED DESCRIPTION

Modern switching hardware supports multiple complex packet headers, such as Multi-Protocol Label Switching (MPLS), IP-in-IP, stacked VLAN, and IPv6 options. A switch should be able to modify the multiple packet headers at packet rates exceeding 800 million packets per second, and at low latency.

Low-latency modification of multi-header packets may be done with the use of multiple concurrent header modifications. A compactor enables standard transmission after multiple headers have been modified, after which individual sizes of each of the multiple headers may have changed. To maintain a throughput of one packet per cycle, compacting can be performed using a wide datapath. A wide datapath concatenates all headers in a parallel structure, in contrast to a serial datapath, which must increase the pipeline depth (and therefore latency) in linear proportion to the number of headers that can be simultaneously supported in a packet. Wide datapath compaction can be performed with a highly parallel structure such as a wide crossbar, or butterfly switches. In either case, these switches consume large areas of a chip. Additionally, butterfly switches require multiple permutation stages while still consuming almost as much chip space as a wide crossbar switch.

Various embodiments of a compactor to transform packet headers use less chip area and power by up to at least three times as compared to a wide crossbar of similarly low latency and almost half as much chip area as compared to a butterfly-based compactor. In one example embodiment, control logic may be used to calculate a destination lane of each word, in an array of eight-bit words making up the multiple headers, by counting a number of previous words that are present. Note that each of the multiple headers may be comprised of multiple words. A sequence of permutation datapath stages, circuits, or logic (e.g., level 1 permutation, level 2 permutation, etc.) are then used to place the words into the correct position utilizing a modulus of 16̂n, where n=1 . . . N, corresponding to the stage number (e.g., the level of permutation). “MOD M,” “MOD L” (where L can be the same as M, or the square root of M, or any other value), or “MOD 16” is the nomenclature used throughout the description herein. In embodiments, the number of words received by the control stage can equal the number of destination lanes, in which case fewer (or one) permutation levels can be implemented to result in correct placement. Embodiments can accomplish the header transformation in a single machine cycle, resulting in very low latency. Note that other modulus numbers may be used in further embodiments, such as 8, 32, or higher for example. Sixteen is a convenient size for a current single state hardware multiplexor (mux). Some embodiments employ N−1 permutation levels (almost half as many as prior butterfly implementations) and a small control logic consisting of simple running-sum and decoders.

If there are 256 words to be processed and reordered, the control places all the words into the correct output lane MOD 16 words. If the individual headers are already compacted, in various embodiments, this entails a simple rotation of 16 word chucks. The term “compacted” is used herein to signify that there are no null or blank words in the header. If there are blank words, words following the blank words are moved such that each header ends up being contiguous, with no blank words, and followed by the next of the multiple headers. Rotation can be performed by specifying a number of lanes to move all the words, and then moving all the words by that specified number.

The next permutation level (e.g., the level 2 permutation) places all the words into an output lane (e.g., correct lane) MOD 256 words, providing the so modified multiple headers as an output. If there are more than 256 words, then additional permutation levels may be used, continuing the pattern.

In one embodiment, 16×16 crossbar switches are used in both the level 1 permutation stage, circuit, or logic and level 2 permutation stage, circuit, or logic. A third or additional permutation levels can also be included. In each 16×16 crossbar switch, each of 16 inputs is mapped to a unique one of 16 outputs. Each 16×16 crossbar switch takes, as an input, the next contiguous block of input words. For example, a first crossbar switch takes input words 0-15, the next takes input words 16-31, etc. A chunk can be defined as a block of 16 input words that goes to the same level 1 permutation crossbar. The control logic may use simple running-sum components and decoders, requiring very little chip area. For example, a parallel-prefix tree structure could be used in some embodiments to implement running-sum. Thus, embodiments use a total of 32 smaller switches for compaction of the multiple headers as opposed to a wide 256×256 crossbar switch, thereby saving chip space and power.

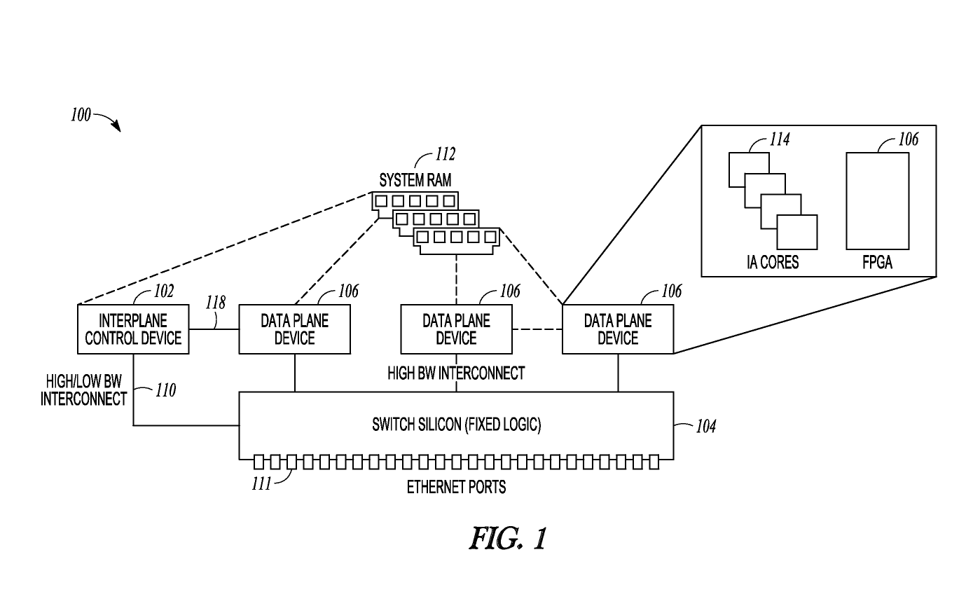

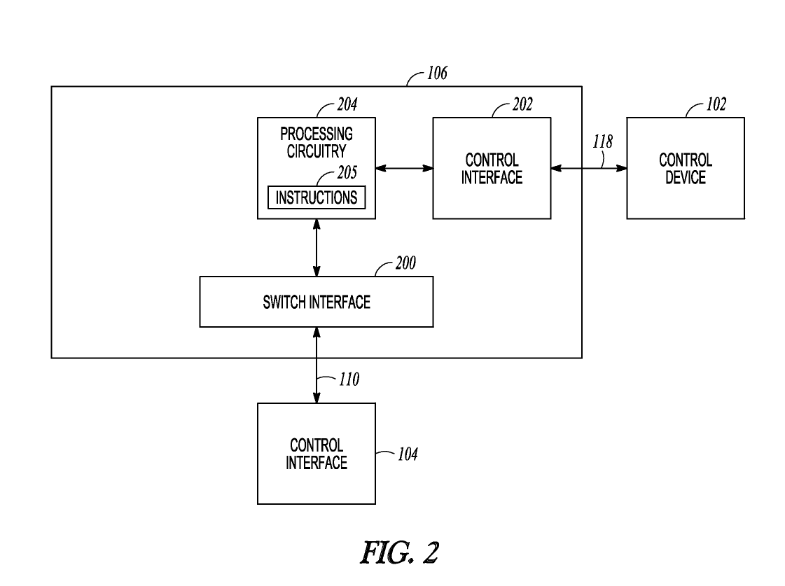

FIGS. 1 and 2 provide a high level view of an example switching platform, followed by figures describing example embodiments of header compacting, and a final figure illustrating hardware.

FIG. 1 is a block diagram illustrating components of a switching platform 100 in which methods in accordance with some embodiments can be implemented. A network operating system (in kernel or user space) runs on the switching platform 100 and, among other functionalities, manages a hardware switch 104, data plane devices 106, and associated accelerators programmed in the FPGA 108. The hardware switch 104 can include fixed-logic switch silicon (switch Si) circuitry or other hardware circuitry, and the hardware switch 104 can include a switch of the Intel® Ethernet Switch family, available from Intel Corporation of Santa Clara, Calif. Each of the data plane devices 106 are connected to the hardware switch 104 using very high-bandwidth, low-latency interconnects 110, which can support speeds of, for example, 10-100 Gigabit Ethernet (GbE) or higher. Additionally the data plane devices 106 are interconnected among each other to make a coherent fabric to access extended flow tables provided in random access memory (RAM) 112 of the switching platform 100, or to pass packets from one data plane device 106 to the next, among other uses.

The control device 102 initializes the hardware switch 104 and programs the switch ports of the hardware switch 104 facing the data plane devices 106, using flexible interfaces, to provide scalable flow processing that can be adapted for various usage models in addition to other data center usage models. The hardware switch 104 also receives packet streams and connects to other devices or systems using Ethernet ports 111. The control device 102 can execute (e.g., “run”) on a specialized core in some embodiments. Alternatively, in other embodiments, the control device 102 (or processing circuitry of the control device 102) can be distributed among one or more Intel Architecture® (IA) cores 114, by way of nonlimiting example.

FIG. 2 illustrates a data plane device 106 in accordance with some embodiments. The data plane device 106 includes a switch interface 200 to communicate with one or more hardware switches such as for example the hardware switch 104 shown in FIG. 1. The data plane device 106 can act as a communication packet processing device as described in more detail herein.

The data plane device 106 also includes a control interface 202 to communicate with one or more control devices 102 (FIG. 1).

The data plane device 106 includes processing circuitry 204 to perform functions such as packet header compaction and updating CRC of headers. It will be understood that any or all of the functions performed by processing circuitry 204 can be executed with hardware, software, firmware, or any combination thereof, on one or more processing cores, for example IA cores 114 or a core of the control device 102.

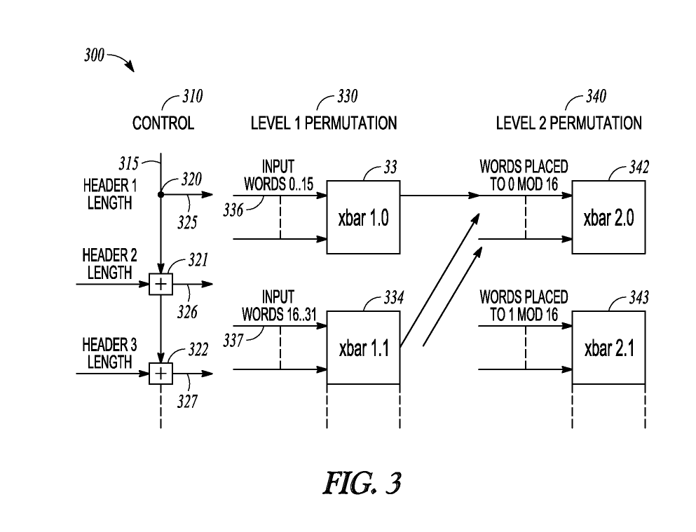

In embodiments, the processing circuitry 204 can determine destination lanes for multiple received headers that have been received at the switch interface 200 and permute words of the multiple received headers as described later herein with respect to FIGS. 3-6. The processing circuitry 204 can distribute the plurality of packet streams between the one or more hardware switches (e.g., the hardware switch 104 (FIG. 1) and software data plane components. Software data plane components can include elements for various functions, and software data plane components can execute on IA cores 114.

FIG. 3 is a block diagram of a compactor 300 to transform packet headers received from another datapath (e.g., a routing table or a tunnel-endpoint table by way of nonlimiting example). The compactor 300 will calculate the destination lanes of all the words received from the other datapath. The compactor 300 may be implemented in one or more of the elements of the switching platform 100 such as in data plane devices 106. Compactor 300 includes a control stage 310 coupled to receive multiple headers of a packet and having control logic that determines a destination lane of each input word of the multiple headers by counting the number of previous words that are present.

The headers are received at 315. The length in words for each header is calculated via an adder as shown at 320, 321, and 322, and lanes for each header are output at lines 325, 326, 327, etc. In one embodiment, there are 16 adders and outputs corresponding to a 256 byte header, where each byte is a word comprising 8 bits. A running length calculation on header lengths is performed to determine the correct output lane or lanes for each header. For example, the first header calculation is trivial, because the first header is first. The first word of the first header becomes output word zero, followed by the rest of the words of the first header occupying word one, two, etc., up to the length of the header in words. The ultimate location of the second header depends on the size of the first header. If the first header had seven words, then the second header starts at word 7, and may also occupy words 8, 9, etc., up to the length in words of the second header. If the second header stops at word 9, by way of nonlimiting example, then the third header resumes at word 10.

The lanes for each header determined by the control stage 310 are then used to control a level 1 permutation 330 coupled to the control stage 310. Level 1 Permutation 330 includes multiple crossbar switches indicated at 333, 334, etc. In one embodiment, 16 such crossbar switches are used in the level 1 permutation 330. Each crossbar switch receives 16 words, with the first crossbar switch 333 receiving input words 0-15 as indicated at 336, the second crossbar switch 334 receiving input words 16-31 as indicated at 337, etc. The level 1 permutation 330 places all the words into the correct output lane MOD 16 words as directed by the control stage 310. If the individual headers are already compacted, the level 1 permutation 330 performs a simple rotation of 16 word chunks.

A level 2 permutation 340 consisting of multiple crossbar switches indicated at 342, 343, etc., is coupled to the level 1 permutation 330. The level 2 permutation 340 places all the words into the correct output lane MOD 256 words. The representation of the levels or stages is compacted for ease of illustration, and thus not all individual elements and connections are visible, but would be apparent to one of skill in the art. In one embodiment, crossbar 342 handles words placed to 0 MOD 16, which includes words zero, 16, 32, 48, etc. Crossbar 343 handles words placed 1 MOD 16, which includes words one, 17, 33, 49, etc. The crossbars of the level 2 permutation 340 produce an interleaved output of the headers. If there are more than 256 words, then additional levels continue the pattern. The header is now fully compacted and correctly ordered for transfer from the switching platform 100.

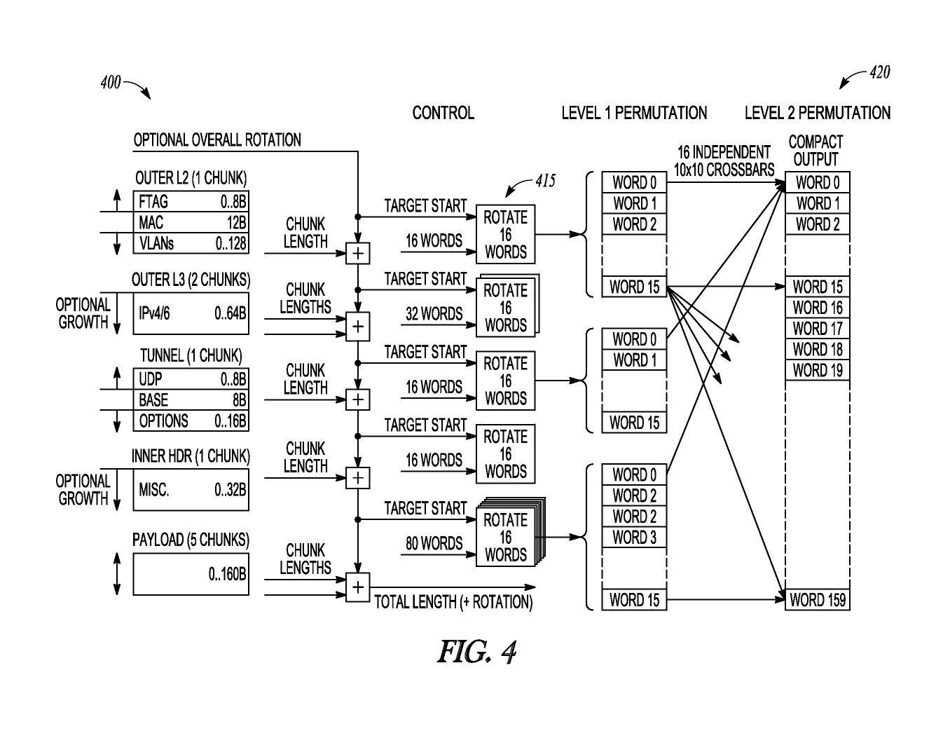

FIG. 4 is a block diagram of an alternative header transformation mechanism 400 that compacts up to 320 Bytes (i.e. 160 words) in three stages of logic. A first stage of logic comprises control logic indicated at 410. Control logic 410 receives the packet headers and calculates a destination lane of each 16-bit input word by adding all previous header sizes to a constant offset of the word within the header. Chunk lengths are used to determine a target start for each header, where a chunk is a block of 16 input words that goes to the same level 1 permutation crossbar as described earlier herein. Thus, a calculation of the position of each word is avoided by feeding at most, one header into each level 1 permutation crossbar indicated at 415. The representation of the stages is compacted for ease of illustration, and thus not all individual elements and connections are visible, but would be apparent to one of skill in the art. In some applications, an optional overall rotation to the compacted result may be performed by adding the desired overall rotation into the control logic as noted in FIG. 4.

Level 1 permutation at 415 rotates the 16 words, which can be accomplished by simply specifying the number of positions to rotate, which is then applied to each word. Note that while a crossbar is shown, other logic circuity may be used to perform such simple rotations.

Level 1 permutation at 415 places all words into the correct lane MOD 16 words. In this example embodiment, the individual headers are already internally compacted when received by mechanism 400, so this is a simple rotation within 16-word chunks, which results in savings on the amount of control utilized to transform the headers. Each header is 1-2 chunks and the payload is 5 chunks. This rotation is conflict-free because each chunk of header is at most 16 words. Therefore, the destination lanes of these 16 words do not have any conflicts MOD 16. This property holds even if the headers had not initially been compacted. Given any set of 16 words to be compacted in one of the level 1 permutation crossbars, the resulting positions are a consecutive run of no more than 16 words, and therefore each of these words is destined to a different level 2 permutation crossbar. A similar property holds at each later stage or level.

The level 2 permutation at 420 places all words into the correct output lane. The placement is achieved via 16 independent 10×10-word crossbars in one embodiment. The control logic for the level 2 permutation at 420 can be computed as a 160-bit destination-mask per chunk. The mask is set to is over the range (start . . . start+length−1) that was calculated for that chunk in the control logic 410. For lowest latency, this mask generation occurs in parallel with the level 1 permutation.

The crossbar function in the level 2 permutation 420 takes each output word from the word having the same position MOD 16, and its corresponding destination mask bit set. This amounts to a 10-input mux per output, with one-hot control per mux.

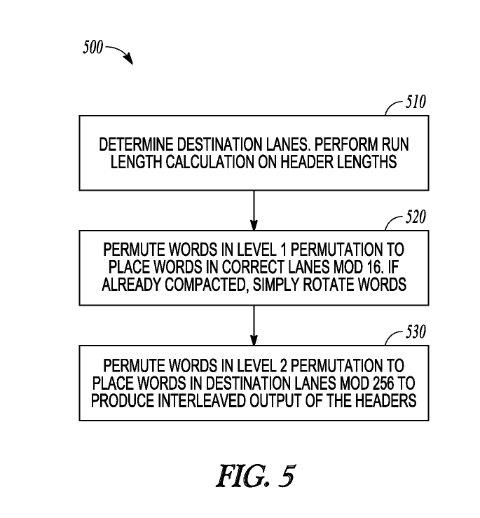

FIG. 5 is a flowchart illustrating operation of the stages or levels of compactor 300 to perform a method 500 of processing communication packets. In one embodiment, the method includes determining at 510, destination lanes for multiple received headers of a communication packet to provide determined destination lanes. A running length calculation on header lengths is performed to determine the correct output lane or lanes for each header. For example, the first header at is trivial, because it is first. The first word of the first header becomes output word zero, followed by the rest of the words of the first header occupying word one, two, etc., up to the length of the header in words. For the second header, its ultimate location depends on the size of the first header. If the first header had seven words, then the second header starts at word 7, and may also occupy words 8, 9, etc., up to the length in words of the second header. If it stops at word 9, the third header resumes at word 10.

At 520, words of the headers are permuted in a level 1 permutation to place words into a correct lane according to the determined destination lanes. In one embodiment, the compactor receives multiple headers for a packet comprising 256 words. The level 1 permutation may use crossbar switches to place all the words into the correct lane MOD 16 words as directed by the control stage. Note that 16 is the square root of 256. If the individual headers are already compacted, the level 1 permutation performs a simple rotation of 16 word chunks.

At 530, words received from the level 1 permutation are permuted in a level 2 permutation to place each word into a correct destination lane according to the determined destination lane. Multiple crossbar switches may be used in the level 2 permutation to place all the words into the correct lane MOD 256 words. In one embodiment, a first crossbar switch handles words placed to 0 MOD 16, which includes words zero, 16, 32, 48, etc. A next crossbar switch handles words placed 1 MOD 16, which includes words one, 17, 33, 49, etc. The crossbars of the level 2 permutation produce an interleaved output of the headers. If there are more than 256 words, then additional levels continue the pattern. The header is now fully compacted and correctly ordered for transfer from the switching platform.

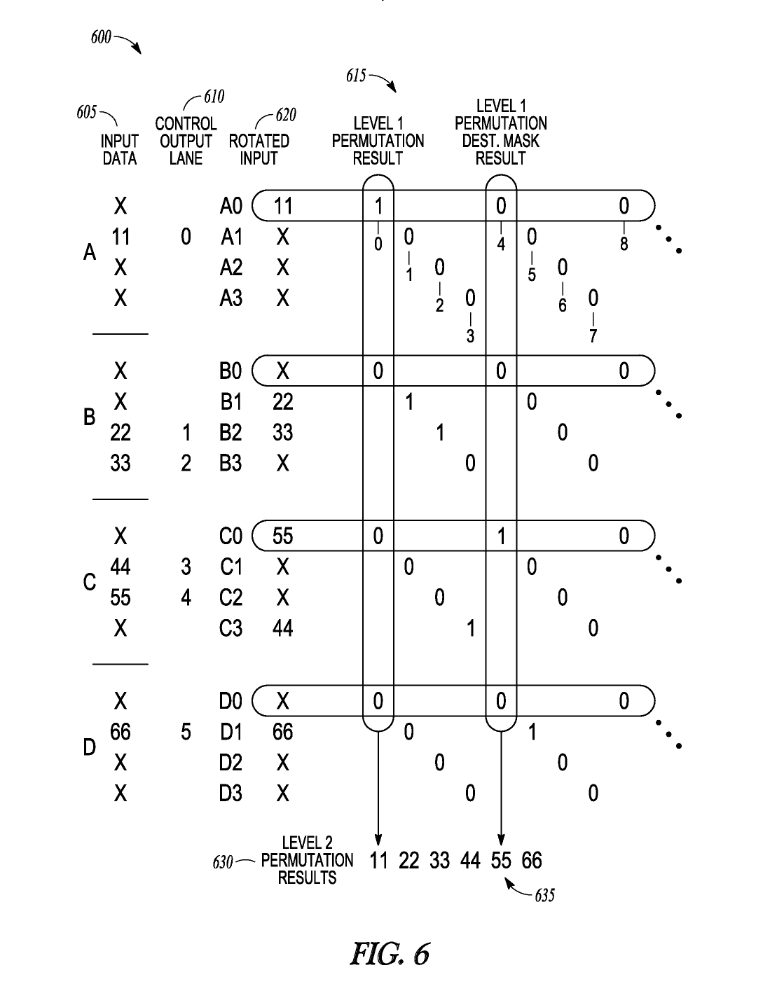

FIG. 6 is a data flow representation of a 16-word compactor indicated generally at 600. FIG. 6 can be compared and contrasted with FIG. 4 in that FIG. 4 illustrates a similar 256-word compactor. 16 words was chosen to allow ease of representation in a single sheet of drawing. Input data 605 includes 16 input words. Invalid words are represented with an “X”. The input words are organized into 4 blocks of 4 words each. The blocks are labeled: A, B, C, and D, and individual words are labeled A0, A1, A2, A3; B0, B1, B2, B3; C0, C1, C2, C3; and D0, D1, D2, and D3.

A control stage is indicated at 610 and includes logic to calculate output lanes of all words. In addition to other operations, the control stage 610 can remove invalid words. In the example of FIG. 6, the input blocks are already compacted so a “rotation amount” per A, B, C, and D may be used.

The level 1 permutation at 615 receives the rotated input at 620 and places all words into correct position MOD 4. Since the input blocks are already compacted, this is just a rotation. Level 1 permutation also calculates a 16-bit destination mask for each rotated block as shown at 625. In the level 1permutation at 615, A, B, C and D are processed independently and accordingly space can be saved in various embodiments at least because only 4×4 crossbars are needed in the level 1 permutation 615.

Level 2 permutation is indicated at 630 and may be an array of 4-input muxes, each controlled by 1-of-4 one-hot. The level 2 permutation result is indicated at 635 and shows each word in a correct lane, resulting in a compacted contiguous header block as an output for the packet. In the level 2 permutation indicated at 630, each output (e.g., output 0, 1, 2, 3, 4, 5, 6, 7 and 8 shown in FIG. 6) can only come from a set of specific locations. For example, output 0 can only come from A0, B0, C0 or D0; output 1 can only come from A1, B1, C1 or D1; output 2 can only come from A2, B2, C2 or D2; and output 3 can only come from A3, B3, C3 or D3. Accordingly, 4×4 crossbars may be used to implement the level 2 permutation, resulting in further space savings in various embodiments.

The term “module” is understood to encompass a tangible entity, be that an entity that is physically constructed, specifically configured (e.g., hardwired), or temporarily (e.g., transitorily) configured (e.g., programmed) to operate in a specified manner or to perform at least part of any operation described herein. Considering examples in which modules are temporarily configured, a module need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. The term “application,” or variants thereof, is used expansively herein to include routines, program modules, programs, components, and the like, and may be implemented on various system configurations, including single-processor or multiprocessor systems, microprocessor-based electronics, single-core or multi-core systems, combinations thereof, and the like. Thus, the term application may be used to refer to an embodiment of software or to hardware arranged to perform at least part of any operation described herein.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions 205 for execution by a machine (e.g., the control device 102 or any other module) and that cause the machine to perform any one or more of the techniques of the present disclosure, or that is capable of storing, encoding or carrying data structures used by or associated with such instructions. In other words, the processing circuitry 204 (FIG. 2) can include instructions and can therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 205 may further be transmitted or received over a communications network using a transmission medium utilizing any one of a number of transfer protocols (e.g., frame relay, internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1x* standards and Long Term Evolution (LTE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The term “transmission medium” shall be taken to include any intangible medium that is capable of storing, encoding or carrying instructions for execution by hardware processing circuitry, and includes digital or analog communications signals or other intangible medium to facilitate communication of such software.

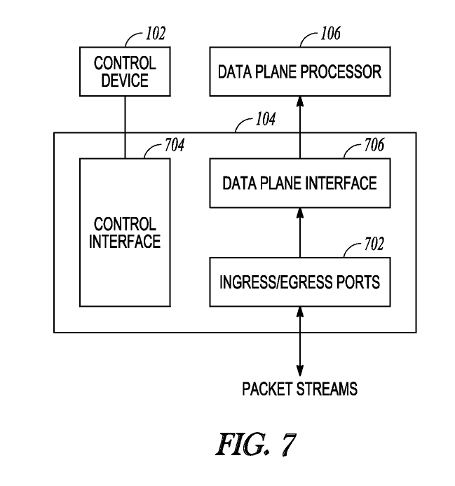

FIG. 7 is a block diagram of hardware switch 104 in accordance with some embodiments. The hardware switch 104 includes ingress ports (for example ingress/egress ports 702) for receiving multiple headers of a packet comprised of multiple words and to provide the multiple headers to control circuitry. The ingress/egress ports 702 can also be referred to as Ethernet ports, communication ports, etc. and the ingress/egress ports 702 can include processing circuitry (not shown in FIG. 7) for parsing, routing, packet modification, etc.

The hardware switch 104 includes a control interface 704 to communicate with a control device 102 and a switch data plane interface 706 to communicate with one or more data plane devices 106. Accordingly, a basic switch 104 pipeline can include receiving data at ingress/egress ports 702, performing processing at ingress/egress ports 702 (such as parsing, routing modification of packets, etc.), and providing packets to the data plane interface 706 or other circuitry. The switch 104 pipeline can include further combinations of the above, for example, after modification of packets is complete, parsing may be performed again. Packet processing and modification can also be implemented in the one or more data plane devices 106.

As described earlier herein, the hardware switch 104 can provide capability information, over the control interface 704, to the control device 102. The hardware switch 104 can determine a destination lane for each word of the multiple headers by counting previous words of the multiple headers to provide a determined destination lane for each word. The hardware switch 104 can place each word into a correct lane responsive to the determined destination lane, and place each word into a correct designation lane responsive to the determined destination lane. The hardware switch 104 can include any number or configuration of crossbars, for example, at least one set of 16×16 crossbars.

### ADDITIONAL NOTES & EXAMPLES

Example 1 includes subject matter (such as a control device, interplane control device, control plane processor, communication packet processing device, computer device and or any other electrical apparatus, device or processor) including a control stage coupled to receive multiple headers of a packet comprised of multiple words, and to determine a destination lane for each word of the multiple headers by counting previous words of the multiple headers to provide a determined destination lane for each word; a level 1 permutation circuit coupled to the control stage to place each word into an output lane according to the determined destination lane; and a level 2 permutation circuit having an input coupled to an output of the level 1 permutation circuit, the level 2 permutation circuit to place each word into a correct designation lane according to the determined destination lane.

In Example 2, the subject matter of Example 1 can optionally include wherein the control stage is configured to receive M words, the level 1 permutation circuit places words into the output lane MOD L, and the level 2 permutation circuit places words into destination lanes MOD M, where L is less than M.

In Example 3, the subject matter of Example 2 can optionally include wherein M is equal to the number of destination lanes.

In Example 4, the subject matter of Example 2 can optionally include wherein L is the square root of M.

In Example 5, the subject matter of Examples 2-4 can optionally include wherein M=256 and L=16.

In Example 6, the subject matter of Example 2 can optionally include wherein M>256, L=16, and further comprising a third permutation level.

In Example 7, the subject matter of any of Examples 1-6 can optionally include wherein the control stage determines the destination lane of a word by counting a number of previous words that are present.

In Example 8, the subject matter of any of Examples 1-7 can optionally include wherein the control stage receives compacted headers and determines a rotation amount, and wherein the level 1 permutation circuit rotates words by the rotation amount determined by the control stage.

In Example 9, the subject matter of any of Examples 1-8 can optionally include wherein the control stage determines a destination mask and wherein the level 2 permutation circuit comprises multiple independent crossbar switches utilizing the destination mask to place the words into destination lanes.

In Example 10, the subject matter of any of Examples 1-9 can optionally include wherein the level 1 permutation circuit comprises multiple crossbar switches configured to place words MOD 16.

In Example 11, the subject matter of Example 10 can optionally include wherein the level 2 permutation circuit comprises multiple crossbar switches to place words MOD 256, corresponding to a count of the number of words comprising the multiple headers.

In Example 12, the subject matter of any of Examples 1-11 can optionally include wherein the control stage removes invalid words from the multiple headers.

Example 13 includes subject matter include a method, the method comprising determining destination lanes for multiple received headers of a communication packet to provide determined destination lanes; permuting words of the multiple received headers in a level 1 permutation circuit to place words into an output lane according to the determined destination lanes; and permuting words received from the level 1 permutation circuit in a level 2 permutation circuit to place each word into a correct destination lane according to the determined destination lane.

In Example 14, the subject matter of Example 13 optionally includes wherein there are M words in the multiple received headers, permuting words of the multiple received headers in the level 1 permutation circuit places words into the output lane MOD L, and permuting words in the level 2 permutation circuit places words into the destination lanes MOD M, where L is less than M.

In Example 15, the subject matter of Example 14 optionally includes wherein M=256 and L=16.

In Example 16, the subject matter of Example 15 optionally includes wherein M>256, L=16, and further comprising permuting additional words in a third permutation level.

In Example 17, the subject matter of any of Examples 13-16 optionally includes wherein determining the destination lane of a word comprises counting a number of previous words that are present and wherein determining destination lanes further comprises removing invalid words from the multiple received headers.

In Example 18, the subject matter of any of Examples 13-17 optionally includes wherein the level 1 permutation circuit uses multiple crossbar switches configured to place words MOD 16 and wherein the level 2 permutation circuit uses multiple crossbar switches to place words MOD 256, corresponding to the number of words comprising the multiple received headers.

Example 19 includes subject matter such as a machine-readable medium including instructions that, when executed on a machine (such as a control device, interplane control device, control plane processor, data plane device, data plane processor, computing device, NIC card, hardware switch, etc.) cause the machine to perform operations comprising determining destination lanes for multiple received headers of a communication packet to provide determined destination lanes; permuting words of the multiple received headers in a level 1 permutation circuit to place words into an output lane responsive to the determined destination lanes; and permuting words received from the level 1 permutation circuit in a level 2 permutation circuit to place each word into a correct destination lane in accordance with the determined destination lanes.

In Example 20, the subject matter of Example 19 may optionally include wherein there are L words in the multiple received headers, permuting words of the multiple received headers in the level 1 permutation circuit places words into the correct lane MOD 16, and permuting words in the level 2 permutation circuit places words into the destination lanes MOD 256.

In Example 21, the subject matter of any of Examples 19-20 may optionally include wherein determining the destination lane of a word comprises counting a number of previous words that are present and wherein determining destination lanes further comprises removing invalid words from the multiple received headers.

Example 22 include a mechanism (e.g., a hardware switch, fixed-logic silicon switch, etc.) comprising ingress ports for receiving multiple headers of a packet comprised of multiple words and to provide the multiple headers to control circuitry; control circuitry coupled to the ingress ports and configured to receive the multiple headers, determine a destination lane for each word of the multiple headers by counting previous words of the multiple headers to provide a determined destination lane for each word, place each word into a correct lane responsive to the determined destination lane, and place each word into a correct designation lane responsive to the determined destination lane.

Example 23 includes the subject matter of Example 22, and may optionally include wherein the control circuitry includes a plurality of 16×16 crossbars.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A communication packet processing device comprising:
a control stage coupled to receive multiple headers of a packet comprised of multiple words, and to determine a destination lane for each word of the multiple headers by counting previous words of the multiple headers to provide a determined destination lane for each word;
a level 1 permutation circuit coupled to the control stage to place each word into an output lane according to the determined destination lane; and
a level 2 permutation circuit having an input coupled to an output of the level 1 permutation circuit, the level 2 permutation circuit to place each word into a correct designation lane according to the determined destination lane.

2. The device of claim 1 wherein the control stage is configured to receive M words, the level 1 permutation circuit places words into the output lane MOD L, and the level 2 permutation circuit places words into destination lanes MOD M, where L is less than M.

3. The device of claim 2, wherein M is equal to the number of destination lanes.

4. The device of claim 2 wherein L is the square root of M.

5. The device of claim 4 wherein M=256 and L=16.

6. The device of claim 2 wherein M>256, L=16, and further comprising a third permutation level.

7. The device of claim 1 wherein the control stage determines the destination lane of a word by counting a number of previous words that are present.

8. The device of claim 1 wherein the control stage receives compacted headers and determines a rotation amount, and wherein the level 1 permutation circuit rotates words by the rotation amount determined by the control stage.

9. The device of claim 1 wherein the control stage determines a destination mask and wherein the level 2 permutation circuit comprises multiple independent crossbar switches utilizing the destination mask to place the words into destination lanes.

10. The device of claim 1 wherein the level 1 permutation circuit comprises multiple crossbar switches configured to place words MOD 16.

11. The device of claim 10 wherein the level 2 permutation circuit comprises multiple crossbar switches to place words MOD 256, corresponding to a count of the number of words comprising the multiple headers.

12. The device of claim 1 wherein the control stage removes invalid words from the multiple headers.

13. A method of processing communication packets, the method comprising:
determining destination lanes for multiple received headers of a communication packet to provide determined destination lanes;
permuting words of the multiple received headers in a level 1 permutation circuit to place words into an output lane according to the determined destination lanes; and
permuting words received from the level 1 permutation circuit in a level 2 permutation circuit to place each word into a correct destination lane according to the determined destination lane.

14. The method of claim 13 wherein there are M words in the multiple received headers, permuting words of the multiple received headers in the level 1 permutation circuit places words into the output lane MOD L, and permuting words in the level 2 permutation circuit places words into the destination lanes MOD M, where L is less than M.

15. The method of claim 14 wherein M=256 and L=16.

16. The method of claim 15 wherein M>256, L=16, and further comprising permuting additional words in a third permutation level.

17. The method of claim 13 wherein determining the destination lane of a word comprises counting a number of previous words that are present and wherein determining destination lanes further comprises removing invalid words from the multiple received headers.

18. The method of claim 13 wherein the level 1 permutation circuit uses multiple crossbar switches configured to place words MOD 16 and wherein the level 2 permutation circuit uses multiple crossbar switches to place words MOD 256, corresponding to the number of words comprising the multiple received headers.

19. A hardware switch comprising:
ingress ports for receiving multiple headers of a packet comprised of multiple words and to provide the multiple headers;
control circuitry coupled to the ingress ports and configured to
receive the multiple headers,
determine a destination lane for each word of the multiple headers by counting previous words of the multiple headers to provide a determined destination lane for each word,
place each word into an output lane responsive to the determined destination lane, and
place each word into a designation lane responsive to the determined destination lane.

20. The hardware switch of claim 19, wherein the control circuitry includes a plurality of 16×16 crossbars.
